(19) United States
(12) Patent Application Publication
(10) Pub. No.: US 2026/0225855 A1
(43) Pub. Date: Aug. 6, 2026

(54) PLATFORM FOR AN ELEVATOR SYSTEM FOR A BUILDING WHICH IS UNDER CONSTRUCTION

(71) Applicant: INVENTIO AG, Hergiswil (CH)

(72) Inventors: Lukas Christen, Geltwil (CH); Eliane Bitterli, Kappel (CH)

(21) Appl. No.: 19/142,363

(22) PCT Filed: Dec. 11, 2023
(86) PCT No.: PCT/EP2023/085135

§ 371 Date: Jun. 23, 2025

(30) Foreign Application Priority Data
Dec. 29, 2022 (EP) 22217140.7

(51) Int. Cl. B66B 11/00; B66B 19/00

(52) U.S. Cl. CPC B66B 11/0005; B66B 19/00

(57) ABSTRACT

An elevator system, for a building which is under construction, includes an elevator shaft which becomes taller as the building height increases during the construction phase of the building. A platform with a sealing arrangement for sealing or closing a gap between the platform and the elevator shaft is positioned in the shaft. The sealing arrangement has side elements that seal against the shaft walls and corner elements that seal with respect to the corner regions between the shaft walls. The side elements are struck against the shaft walls by moving the corner elements to an active position using quick-action clamps.

### FIELD

The invention relates to a platform for an elevator system comprising an elevator shaft which becomes taller as the building height increases during the construction phase of the building, and to such an elevator system. This elevator system can be used in particular on high-rise construction sites.

### BACKGROUND

During the construction of the building, the lower floors created first can be finished to such an extent that they are already habitable or usable for other purposes. For this purpose, the elevator system comprises an elevator car with which the floors already used as residential or business premises can be accessed during the construction phase of the building. The construction-phase elevator having this elevator car grows with the building, so to speak, i.e., the usable lifting height of the construction elevator grows as the height of the building or elevator shaft increases. This makes it possible for construction workers and building materials or optionally users of apartments or business premises already occupied before the building is finished to be conveyed with the elevator car during the construction period of the building. Such an elevator system is known from US 2016/0152442 A1. The elevator system has a machine platform that can be moved along the elevator shaft and from which the elevator car is suspended via support means arranged in the elevator shaft. The machine platform is lifted in order to increase the usable lifting height of the elevator car in the elevator shaft. To lift the machine platform, a platform is provided that can be moved along the elevator shaft to form a support structure, which can be supported on the wall of the elevator shaft. This support structure arranged above the machine platform is lifted to a height at which the platform carried by this support structure can be lifted a certain distance by means of a first lifting device attached in the upper region of the elevator shaft before the machine platform is lifted. A second lifting device, which is arranged on the aforementioned support structure, is used to lift the machine platform.

With the above-mentioned prior art, the elevator car from the construction phase can continue to be used for normal use of the building after the building is completed. However, there are also concepts where, after the building is completed, the elevator car from the construction phase is replaced by a new elevator car. In such a case, the construction-phase elevator car can be configured as a self-propelled elevator car. Such a self-propelled elevator car, which is used in an elevator system for a building which is under construction, comprising an elevator shaft that becomes taller as the building height increases during the construction phase of the building, has become known, for example, from WO 2019/238530 A1. Here, too, different platforms are used.

The construction of elevator shafts in buildings may be done using such climbing formwork. Climbing formwork is among the discontinuous formwork systems and is used to manufacture tower-like structures. It can be used to create concrete portions for the elevator shaft floor by floor. Water is used when concreting. However, unwanted water ingress into the shaft can also occur due to weather conditions, for example during heavy rainfall. Furthermore, contamination from concrete can also occur. Another problem with elevator systems with increasingly high elevator shafts is that during the construction phase of the building, the construction-phase elevators can be damaged by falling objects. Passengers inside the elevator shaft, such as maintenance personnel located on the elevator car, may also be harmed by falling objects. Also at risk are people who, for example, are on an assembly platform from which the guide rails for guiding the elevator car are assembled.

### SUMMARY

It is an object of the present invention to overcome the disadvantages of the known technology and in particular to provide a platform for an elevator system of the type mentioned at the outset which reliably prevents water from entering the shaft space below the platform and which is easy to handle or operate. The platform should also protect against falling parts and dirt. Furthermore, the elevator system equipped with such a platform should be able to be adapted to the increasing height of the building in a simple and efficient manner.

According to the invention, these and other objects are achieved with a platform having the features described below. The platform for an elevator system for a building which is under construction, comprising an elevator shaft which becomes taller as the building height increases during the construction phase of the building, comprises a sealing arrangement for sealing or closing a gap between the platform and the elevator shaft. The elevator shaft may preferably be an elevator shaft that is substantially rectangular in plan view or in floor plan. In the present document, the term “elevator shaft” should be understood to mean a space in a building under construction, the height of which increases in accordance with the construction progress, wherein the space is dimensioned and configured such that at least one elevator car of an elevator, usually an elevator car and a counterweight of one elevator each, can move upward and downward along vertical tracks in the space. Such an elevator shaft can be a single shaft enclosed by shaft walls with the aforementioned rectangular floor plan.

The sealing arrangement has side elements for sealing with respect to the shaft walls. The sealing arrangement can have at least two, preferably at least three and particularly preferably four side elements for sealing with respect to the shaft walls, wherein one side element is assigned to each of the generally four shaft walls. The sealing arrangement further comprises corner elements for sealing the corner regions between the shaft walls. Depending on how many side elements are present, the sealing arrangement can have at least one, preferably at least two and particularly preferably three and ideally four corner elements.

The side elements can be struck against the shaft walls using the corner elements. A number of advantages can be achieved because the platform has a sealing arrangement with side elements and corner elements, which sealing arrangement is designed in such a way that the side elements can be struck against the shaft walls by means of the corner elements. The aforementioned gap can be reliably sealed. If necessary, the sealing effect can be easily created and, if necessary, canceled manually or by appropriate control. The platform described here is particularly suitable for buildings where elevator shafts are constructed using climbing formwork and for buildings where rapid construction progress is particularly important. The platform with such a sealing arrangement may preferably be an upper protection platform. The sealing arrangement can be used in combination with various types of platforms, which are inherently suitable for the elevator system mentioned above, with an elevator shaft which becomes taller as the building height increases during the construction phase of the building. It is also conceivable that platforms of such elevator systems could be retrofitted.

The sealing arrangement can be designed in such a way that it can be moved between a rest position, in which the sealing arrangement is spaced apart from the elevator shaft or the adjacent shaft wall and thus allows trouble-free vertical movement of the platform, and the aforementioned active position, in which the seal arrangement contacts the shaft wall, so that the gap between platform and elevator shaft is completely or almost completely bridged to close it.

The platform can be designed in such a way that a horizontal clamping element, in particular a quick-action clamp, is provided for each corner element. With just a few simple steps, one person can easily achieve a high sealing effect manually. For example, the platform equipped with the sealing arrangement can be an upper protection platform that forms a protective roof for the assembly platform below. An elevator system for a building which is under construction, comprising this protection platform can be operated very quickly and efficiently with regard to sealing the shaft. Downtimes during which the elevator cannot be operated due to the open gap or no work can be carried out on the assembly platform can be significantly reduced. Thanks to quick-action clamps, water can be quickly and reliably prevented from entering the shaft space below the platform.

In the context of the present invention, quick-action clamps are connecting means that enable a simple and quick connection of two adjacent elements; in this case, this refers to the connection of the corner element to the adjacent corner region of the elevator shaft. For this purpose, so-called lever clamps are suitable, for example, with which the corner element can be easily clamped against the shaft corner with one hand and thus sealed. Of course, other variants of quick-action clamps are also conceivable. In addition, the clamping force can often be adjusted using a threaded rod on the clamping element.

The horizontal clamping element can be designed as an angle clamp. Handling an angle clamp is very easy.

The horizontal clamping element designed as an angle clamp and/or as a quick-action clamp can have a metal main body with two legs at right angles to each other and an adjusting body which is displaceably mounted in the main body and which can be moved for clamping via a quick-action fastener which is articulated in the main body. The quick-action fastener can comprise a backstop that blocks backward movement against the closing direction. For further clamping, the quick-action clamp can be additionally tightened using a threaded rod, thus increasing the clamping force and thus also the sealing effect.

The horizontal clamping element can also be designed as a so-called metal angle clamp, which has an articulated spindle nut for moving a clamping jaw forward and backward with legs at right angles to each other.

The corresponding corner element can comprise an angle profile part preferably made of sheet metal. The angle profile part may have inclined drainage portions for draining water inward. The corresponding corner element can thus comprise the angle profile part and the horizontal clamping element, preferably the quick-action clamp.

The angle profile part of the sealing arrangement can have two vertical wall portions, preferably connected to one another at right angles, and inclined drainage portions arranged below the wall portions and connected to them via folds for draining water inward. The term ‘inward’ means toward the central region of the elevator shaft or platform, while ‘outward’means toward the shaft wall.

The angle profile part made of sheet metal can further have stop portions which serve to strike the angle profile part against the shaft walls in the corner region. When in the active position, the corresponding stop portion can contact the shaft wall directly or indirectly. In the preferred indirect case, the angle profile part has a flexible sealing body that ensures wall contact and thus an optimal sealing effect.

The corresponding corner element of the sealing arrangement can be equipped with a flexible sealing body, which is preferably elastomer-based, and particularly preferably with a rubber seal. The sealing body can have an L-shape in plan view. The sealing body can be a flat sealing profile which is arranged on the stop portion and is preferably fixed to the angle profile part via an adhesive connection, by a vulcanization process or by mechanical fastening means. The rubber seal can have a wall thickness of approximately 2 to 30 mm and preferably approximately 3 to 10 mm, which means that the seal can also withstand the high mechanical stresses during the construction phase, for example due to abrasion on the shaft wall.

The sealing body can consist of an elastic or polymeric material, wherein elastomers and particularly preferably rubber are preferred as polymeric materials. The polymeric material can be selected from the group of thermoplastic elastomers, for example olefin-based or urethane-based, cross-linked olefin-based thermoplastic elastomers, thermoplastic copolyesters, styrene block copolymers (SBS, SEBS, SEPS, SEEPS and MBS) and thermoplastic copolyamides. Furthermore, it can contain plasticizer-containing materials, preferably polypropylene, acrylonitrile-butadiene-styrene copolymer, polycarbonate, polyvinyl chloride, polymethyl methacrylate, polyethylene terephthalate, polyurethane and the like, as well as mixtures of these materials.

With regard to the sealing effect and water collection capacity, it can be advantageous if the corner elements are designed in such a way that they project beyond the side elements in the vertical direction.

A further embodiment relates to a platform in which the corresponding side element has a sheet metal side part and a flexible sealing body. The side element can be made of a metal sheet and the side element can contain a flank wall that is inclined at least in an active position. The flexible sealing body is the elastomer-based sealing body already described above and particularly preferably the rubber seal.

For reliable operation, it can be advantageous if the sheet metal side part is pivotably fastened to the platform. By pivoting, the side element can be brought to and from the shaft wall.

Instead of the above construction with sheet metal and rubber, the side element can be constructed substantially from just one component. In this case, the corresponding side element can have a flexible sealing body, which is preferably elastomer-based, wherein the sealing body not only contacts the shaft wall, but also forms a flank wall, so that water can be captured on the shaft wall side by means of the sealing body and guided via the sealing body to a lower drip edge. The flank wall is now no longer rigid, but flexible. The side element could therefore be made more or less entirely of rubber.

The corner element can have engagement portions that can be supported on the side elements. When the active position is created, the engagement portion pushes away the side element assigned to it or adjacent to it and ensures that the side element hits the shaft wall.

It may be advantageous if the corresponding side element has an engagement piece, created by a projection, for example by a hat profile, for the corner element(s), via which the corner element(s) can act on the side element to create the active position. The previously mentioned engagement portion can form the portion of the corner element via which the corner element acts on the side element.

Instead of assigning the projection to the side element, it would be conceivable alternatively or possibly even additionally that the corner element, for example, has stamp-like engagement pieces for acting on the side elements to create the active position, via which engagement pieces the side elements can be moved outward, e.g., in a pivoting movement, for striking against the shaft walls.

The platform may have a flat roof structure to form a protective roof, wherein a drainage gap which is rectangular in plan view is formed between the flat roof structure and the sealing arrangement. Collected water can be easily drained away via the drainage gap using the sealing arrangement. The platform can preferably be a horizontal, walkable, plate-like flat roof structure. For this purpose, the platform can comprise a flat roof structure, which flat roof structure is adapted to the shaft space and almost completely fills it in a plan view. This flat roof structure can be configured as a plate or can comprise a plate. When the flat roof structure is installed or during the construction phase, it is preferably aligned horizontally. The sealing arrangement can be attached to the flat roof structure in an edge region at the top side of the flat roof.

The vertically movable platform in the elevator shaft, which becomes taller with increasing building height, with the sealing arrangement for sealing or closing the gap between the platform and the elevator shaft can further comprise a water collection container arranged below the sealing arrangement. With the water collection container, water can be easily collected and drained away as needed. Such a water collection container could also be advantageous for a sealing arrangement without the initially claimed solution with the side elements and corner elements separate from these.

The water collection container can be designed as a circumferential gutter. This gutter can preferably be positioned below the drainage gap between the flat roof structure and the sealing arrangement in the platform.

The flat roof structure may comprise a roof slab providing a protective roof, with a drip edge arranged at the roof edge for controlled water drainage. Water can drip from the drip edge into the gutter.

A pipe, for example in the form of a water hose, can be connected to the water collection container and in particular to the gutter, through which the water can be led away from the platform.

The water collection container may have a closable water drain opening for draining the water collected in the water collection container.

A further aspect of the invention relates to an elevator system for a building which is under construction, comprising an elevator shaft which becomes taller as the building height increases during the construction phase of the building, and comprising the platform described above.

Finally, a further aspect of the invention relates to a method for erecting an elevator system for a building which is under construction, comprising an elevator shaft which becomes taller as the building height increases during the construction phase of the building, wherein a usable lifting height of the elevator system is adapted to an increasing height of the building by carrying out at least one lifting process, in which lifting process, for example, a machine platform with an elevator drive and an elevator car suspended from the machine platform via support means are lifted in the elevator shaft by means of a lifting device. The method comprises the use of a platform equipped with a sealing arrangement, which sealing arrangement comprises side elements for sealing with respect to the shaft walls and corner elements for sealing with respect to the corner regions between the shaft walls, wherein the side elements can be struck against the shaft walls by means of the corner elements. The seal is activated during the construction phase; in the corresponding active position, the sealing arrangement seals the gap between the platform and the elevator shaft. By moving the corner elements toward the corner regions, the active position is created, in which the side elements strike against the shaft walls by means of the corner elements, so that the sealing arrangement closes the gap between the platform and the elevator shaft during the construction phase. For a lifting process, the seal is brought into the rest position. Here, by moving the corner elements back, the sealing arrangement is brought into the initial position, in which the sealing arrangement is spaced apart from the elevator shaft, allowing the platform to be moved upward without interference. After the lifting process, the seal is returned to the active position to continue the construction phase.

### DESCRIPTION OF THE DRAWINGS

Additional advantages and individual features of the invention are derived from the following description of an exemplary embodiment and from the drawings, in which:

FIG. 1 is a schematic representation of an elevator system for a building which is under construction, comprising an elevator shaft which becomes taller as the building height increases during the construction phase of the building,

FIG. 2 is a plan view of a partial region of a platform and a corner region of the elevator shaft of the elevator system in the manner according to FIG. 1, wherein the platform comprises a sealing arrangement,

FIG. 3 is a perspective view of the corner region of a platform with a sealing arrangement,

FIG. 4 is a perspective view of a platform of such an elevator system which can be moved vertically with increasing building height, according to a further exemplary embodiment,

FIG. 5 shows a detailed view of the platform from FIG. 4, and

FIG. 6 is a perspective view of a further platform.

### DETAILED DESCRIPTION

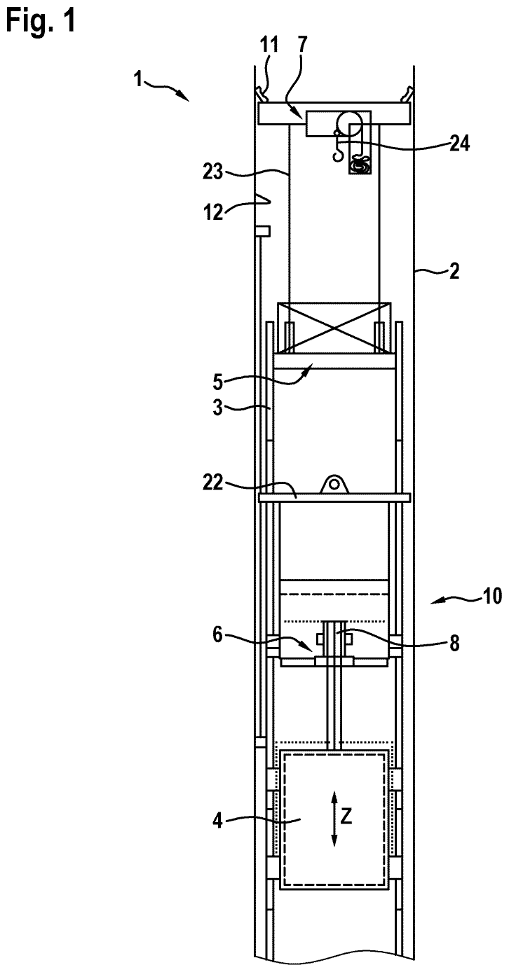

FIG. 1 schematically shows an elevator system 1 for a building 10 which is under construction. The building 10 comprises an elevator shaft 2 that becomes taller as the building height increases over the course of the construction phase. An elevator car 4 is installed in the elevator shaft 2. During vertical movement, the elevator car 4 is guided on at least one guide rail portion 3 attached to a shaft wall 12. Above the elevator car 4, the elevator system 1 has an arrangement for equipping the upward-growing elevator shaft 2 in particular with guide rails for the guide rail portion 3. This arrangement comprises a protection platform 7, a machine platform 6 and an assembly platform 5 arranged between these two platforms 6, 7. The assembly platform 5 is the platform from which the guide rail portion 3 is extended upward. The assembly platform 5 serves as a working platform for assembly personnel. Furthermore, the assembly platform 5 can also be used as transport means for other elevator components to be assembled in addition to the guide rails.

For the sake of simplicity, only one guide rail portion 3 is shown in FIG. 1. Two guide rail portions lying opposite one another are preferably used to guide the elevator car 4. The elevator last mentioned usually comprises not only the elevator car but also a counterweight (not shown here). Multiple guide rail portions are necessary for the optimal linear guidance of the elevator car and the counterweight, wherein each guide rail portion consists of guide rail profile parts arranged in a row.

Except for the region of the elevator shaft 2 extending over a plurality of floors, other parts of the building outside the elevator shaft 2 are not shown in FIG. 1. The special feature of the elevator shaft 2 is the vertical extension which in the case of certain elevator shafts can practically extend over the entire height of the building. The building 10 can comprise one or more such elevator shafts 2. The elevator shaft 2 is designed in the present exemplary embodiment for one elevator having an elevator car and a counterweight. However, the elevator shaft 2 can also be designed for multiple elevators. The elevator shaft 2 could also be designed for a self-propelled construction-phase elevator car.

The elevator car 4 allows the transport of persons and goods to and from the lower floors even during the construction phase of the building. In particular, the elevator car can be used to transport construction workers and building materials. However, users of apartments or business premises already occupied before the building is finished can also be conveyed between at least the floors associated with these spaces in compliance with the regulations.

Viewed in the vertical direction Z, the elevator shaft 2 is divided into a plurality of portions, so to speak. As a lower portion of the elevator shaft 2, which is located below the machine platform 6 with a drive 8 for the elevator, the elevator shaft 2 is already installed with the necessary guide rails for the linear guidance of the elevator car and the counterweight of the elevator for the finished building. In this portion, the elevator system 1 for the building 10 which is under construction has a conventional elevator car 4 and a counterweight (not shown) that can move in the opposite direction. The elevator car 4 presented here could also be replaced by a self-propelled construction phase elevator car 4 for the transport of persons or goods for the duration of the construction phase of the building 10. In this case, the machine platform 6 could be replaced by another platform and in particular a platform without a drive machine for the elevator.

In a rail assembly phase, the at least one guide rail strand 3 is extended upward from the assembly platform 5. This rail assembly phase is shown in FIG. 1. In addition to the assembly of guide rails, further work for the assembly of the shaft equipment or other work steps can be carried out from the assembly platform 5. In the phase referred to simply as the rail assembly phase, the assembly platform 5 can be moved up or down in a vertical direction Z to the desired position via ropes. The assembly platform 5 is suspended from the protection platform 7 via the cable-based lifting device 23.

The protection platform designated by 7 is temporarily fixed in an upper region of the currently existing elevator shaft 2. The protection platform 7 is designed as a support structure. The support structure serves, inter alia, to support the lifting device 23, with which the assembly platform 5 can be moved upward and downward. The protection platform 7 further comprises means 24 for lifting the machine platform 6. However, the protection platform 7 also has the task of protecting persons and equipment in the elevator shaft 2—in particular in the aforementioned assembly platform 5—from objects that could fall down during the construction work taking place on the building 10.

A growth phase can follow the rail assembly phase. After completion of the rail assembly phase and after the elevator shaft 2 has become sufficiently taller as the construction of the building 10 progresses, the protection platform 7 must be positioned to a next higher level. For example, the protection platform 7 is lifted to a next higher level with a construction crane, so that as the building height increases, the upper protection platform can grow with the elevator shaft 2 that has become taller. Under certain circumstances, however, it is also possible to bring the upper protection platform 7 to a next higher level by other means and without the use of a crane. After reaching the next higher level, the protection platform 7 is again temporarily fixed in the elevator shaft 2. Thereafter, the machine platform 6 can be lifted to a next higher level. For this purpose, the protection platform 7 has a lifting means 24, for example a chain hoist. The chain hoist 24 is adapted to connect to an eye on a roof 22 of the machine platform 6 so that the machine platform 6, preferably together with the attached elevator car 4, can be moved upward for a lifting process. However, the movement of the machine platform 6 to the upper operating position could also be carried out by means of other lifting equipment such as by crane, winch, hydraulic hoist or strand jacks. Other elevator systems for a building which is under construction, comprising an elevator shaft which becomes taller as the building height increases during the construction phase of the building, which use additional or alternatively designed platforms, are also known. The special solution for sealing the shaft space shown below using the example of platform 7 and described in detail can basically be used for all types of platforms that are used in such elevator systems.

The platform 7 of the elevator system according to FIG. 1 can also be assigned to a climbing formwork or even be a component of a climbing formwork. The climbing formwork includes formwork (not shown) for concreting. In this case, the platform 7 can thus be configured as a climbing formwork platform for the story-by-story production of concreting portions of the building core comprising the elevator shaft 2. The climbing formwork platform may comprise integrated climbing drives and be configured as a self-propelled climbing formwork platform. However, as shown in FIG. 1, in another variant the climbing formwork platform can be suspended floor by floor in anchors in the shaft walls.

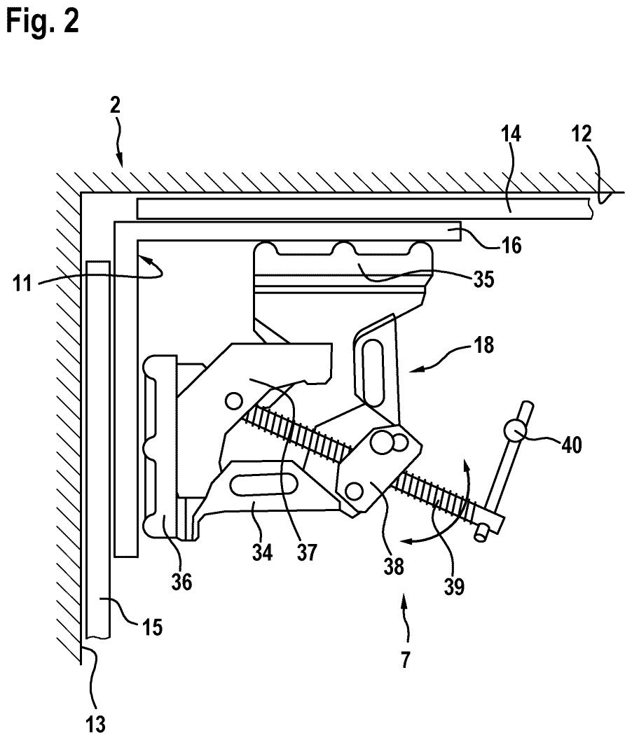

The platform 7 has a horizontal roof structure for covering the elevator shaft 2, on which structure a sealing arrangement designated 11 is arranged. The sealing arrangement 11 serves to pneumatically seal or close the gap between platform 7 and elevator shaft 2. The seal, designed as a circumferential sealing arrangement, is attached to the edge of the platform 7. The sealing arrangement 11 shown in FIG. 2 to FIG. 4 and explained in detail below reliably and simply prevents water, concrete and objects from entering the shaft space below the platform.

FIG. 2 shows a corner region of the elevator shaft 2, wherein the shaft walls 12, 13, which are at right angles to each other, enclose a corner. The sealing arrangement 11 of the platform 7 comprises side elements 14, 15 for sealing with respect to the shaft walls designated 12 and 13. The sealing arrangement 11 further comprises a corner element 16 for sealing the corner regions between the shaft walls 12, 13. Typically, the sealing arrangement 11 comprises four such side elements 14, 15, wherein each side element is associated with a corresponding shaft wall; and four such corner elements 16, wherein each corner element is associated with one of the four corner regions of the elevator shaft. The side elements 14, 15 can be struck against the shaft walls 12, 13 by means of the corner elements 16. In FIG. 2, the sealing arrangement 11 is in a position in which the side elements 14, 15 and the corner element 16 are in contact with the elevator shaft 2 and thus seal it. This position is also referred to hereinafter as the active position.

To create the active position, the sealing arrangement 11 has a horizontal clamping element in the form of a quick-action clamp 18. During closing, the quick-action clamp 18 initially acts on the corner element 16, which then presses the two adjacent side elements 14, 15 against the corresponding shaft walls 12, 13, thus ensuring the sealing effect.

The quick-action clamp 18 comprises a metal main body 34 with two legs 35, 36 at right angles to each other and an adjusting body 37 which is displaceably mounted in the main body and which can be moved for clamping via a quick-action fastener 38 which is articulated in the main body. The clamping force can be adjusted by means of a threaded rod 39 and a toggle handle 40. In this way, the platform 7 can be sealed manually very easily and quickly. Of course, other means could also be used to move the corner element 16 toward the corner so that the side elements strike against the shaft walls. For example, it would be conceivable to use a motor-operated adjustment apparatus to move the corner element 16.

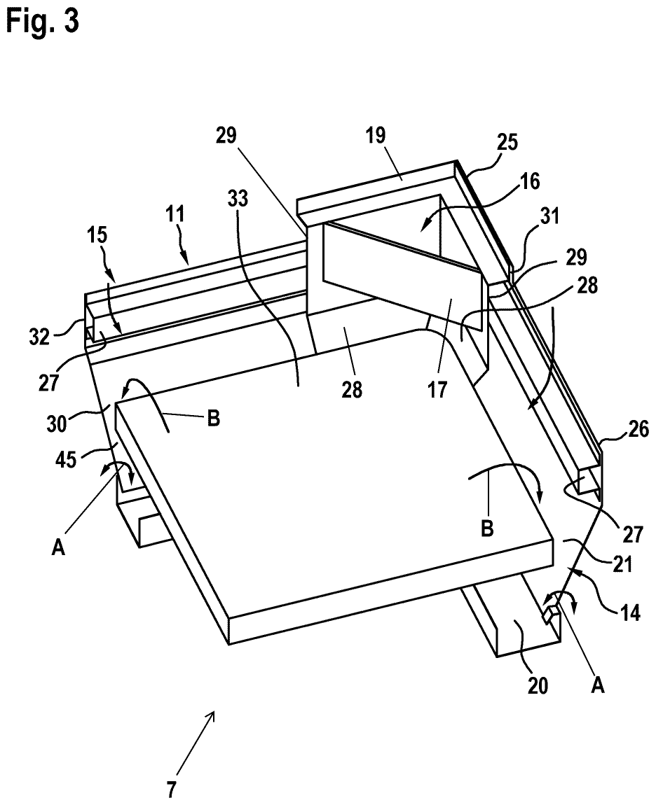

FIG. 3 shows a platform 7 for an elevator system for a building which is under construction with an elevator shaft which becomes taller as the building height increases during the construction phase of the building, comprising a sealing arrangement 11 for sealing or closing the gap between the platform and the elevator shaft. For a better understanding of the construction, no means for moving the corner element 16 of the sealing arrangement 11 are shown in FIG. 3. The sealing arrangement 11 could be motor-operated. However, it may also be advantageous here to use a manual adjustment apparatus such as the quick-action clamp 18 of the exemplary embodiment according to FIG. 2.

The corresponding corner element 16 comprises an angle profile part 19 made of sheet metal. This angle profile part 19, which forms an L in plan view, has two vertical wall portions 29 connected to one another at right angles, to which downwardly inclined drainage portions 28 are connected. The drainage portions 28 serve to drain water inward. The angle profile part 19 further has stop portions 31, which serve to strike the angle profile part against the shaft walls in the corner region. A flat rubber seal 25 is attached to the outer sides of the stop portions 31. When in the active position, the stop portions 31 contact the corresponding shaft walls via this rubber seal 25. Instead of the rubber seal, other elastic polymeric materials can also be used to form a flexible sealing body. Other shapes for the sealing body are also conceivable. Instead of a sealing body designed as a flat sealing profile or a sealing strip, more complicated sealing bodies, such as hollow profile seals, would be conceivable.

The angle profile part 19 with stop portions 31, wall portions 29 and drainage portions 28 can be manufactured from two sheet metal blanks which are joined together by welding after bending processes. The wall portions 29 are then connected to each other via a diagonal reinforcing plate 17 to stiffen the angle.

The side elements 14, 15 arranged further outward on the platform 7 compared to the corner element 16 are constructed similarly. The side elements 14, 15 also have sheet metal parts. In the present case, the corresponding side element 14, 15 consists of a sheet metal side part 45 and a rubber seal 26. The sheet metal side part 45 has an inclined flank wall 30 and an adjoining upper vertical wall portion which forms the stop portion 32 of the side part 14, 15. On the outside of the stop portion 32, a flat rubber seal 26 is attached, which, when in the active position, contacts the corresponding shaft wall. The sheet metal side part 45 can be pivotably fastened to the platform 7 as shown by arrows A. The side element 14, 15 has an engagement piece for the corner element 16 created by a hat profile 27, via which the corner element 16 acts on the side elements 14, 15 to create the active position. The corner element 16 projects beyond the side elements 14, 15 in the vertical direction.

Furthermore, it can be seen from FIG. 3 that a drainage gap 21 is formed between the flat roof structure 33, which is formed in a simplified manner by a plate, and the sealing arrangement 11. This drainage gap, which is rectangular in plan view, has the task of easily draining away collected water using the sealing arrangement 11. The water flows through the drainage gap 21 into the circumferential gutter 20 as shown by arrows B. From this water collection container 20, water can be led away to the next floor via, for example, a hose-like discharge pipe and fed into the sewer system there. Instead of a single plate, the flat roof structure 33 could also be constructed in several parts, for example from planks arranged next to each other.

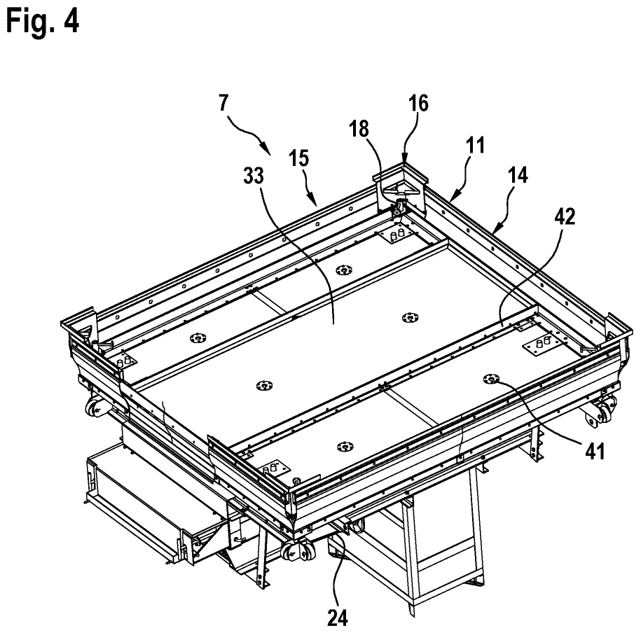

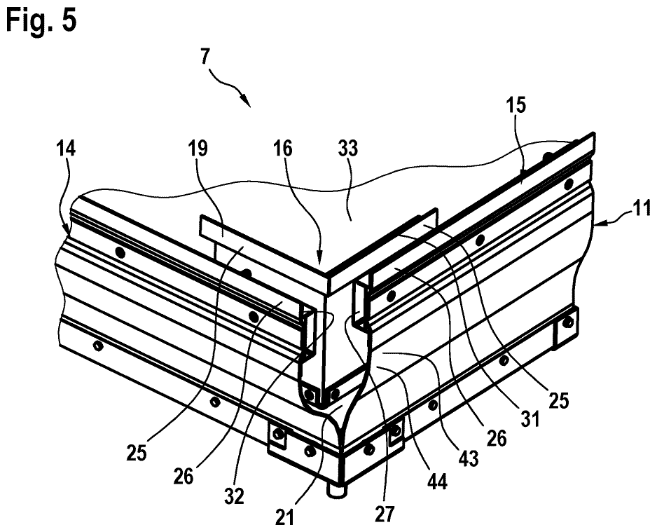

FIGS. 4 and 5 show a platform 7 with an alternative sealing arrangement 11. In this sealing arrangement 11, the corner elements 16 for sealing the corner regions between the shaft walls are designed similarly to the previous exemplary embodiment. The sealing arrangement 11 differs from this in particular in a different design of the side elements 14, 15 for sealing with respect to the shaft walls. The side elements 14, 15 substantially consist of a flat rubber profile which extends vertically from the floor of the platform 7 to the upper end. The corresponding side element 14, 15 thus has a rubber seal 43, wherein this rubber seal 43 not only contacts the shaft wall, but also forms a flank wall 44, so that water can be captured on the shaft wall side by means of the sealing body and guided via the rubber seal 43 to a lower drip edge.

FIG. 4 shows a possible structural design of a protection platform 7, which can be used in elevator systems according to FIG. 1. The platform 7 has movable support elements which can be inserted into recesses in the shaft walls or placed on the shaft floor on the shaft door side to secure the protection platform 7. Also visible is the motorized lifting device 24 comprising the chain hoist. The chain of the chain hoist is stored in a chain storage unit. The chain hoist can be used to move the movable machine platform and the elevator car from a lower temporary operating position to the next upper operating position.

Structural details of the sealing arrangement 11 can be seen in particular from FIG. 5. A hat or box profile 27 is attached to the flat rubber seal 43 as an engagement piece for the corner element 16. The rubber seal 43 is sandwiched between the inner box profile 27 and an outer flat profile.

FIG. 5 also shows a drainage gap 21 between the flat roof structure 33 and the sealing arrangement 11. The water flows through the drainage gap 21 into a circumferential gutter (not shown here).

The platform 7 has a substantially rectangular basic shape in plan view. Several floor drains 41 are provided in the horizontal flat roof structure 33 (FIG. 4). It can also be seen that the flat roof structure 33 is divided into several compartments which are defined by partition walls 42. Water from the floor drains 41 can also be collected and directed into the water tank and from there or, if necessary, even directly via the drainage hose. To form an advantageous plate-like horizontal flat roof structure 33, planks (not shown here) can be provided, for example in the form of wooden boards. Thanks to such planks, it is ensured that the flat roof structure is safe to walk on. The partition walls 42 can reinforce and stiffen the floor. The planks can extend between the corresponding partition walls 42 and can be supported on these partition walls if the partition walls are designed as load-bearing components of the flat roof structure.

In the active position, when the corner elements 16 of the sealing arrangement 11 move the side elements 14, 15 outward, the corner elements 16 are pressed against the shaft corner regions and at the same time the side elements 14, 15 are pressed against the corresponding shaft walls, thereby ensuring the desired sealing effect.

The floor drains 41 shown in FIG. 4 can be arranged in rubber mats or other flexible flat floor elements. Due to the weight of the comparatively heavy floor drains 41 formed by metal components, the floor elements can be curved downward at certain points so that water is not dammed and proper drainage via the floor drains can be ensured.

In a rest position the sealing arrangement 11 is spaced apart from the shaft wall, thereby allowing trouble-free vertical movement of the platform. For example, during the rail assembly phase, the shaft space must be secured and water must be prevented from entering the region below the platform. For this purpose, the sealing arrangement 11 is brought into the active position. In the active position, the sealing arrangement 11 has been moved outward compared to the rest position, so that in order to close the gap between platform 7 and elevator shaft 2, the sealing arrangement 11 contacts the shaft wall by striking against it.

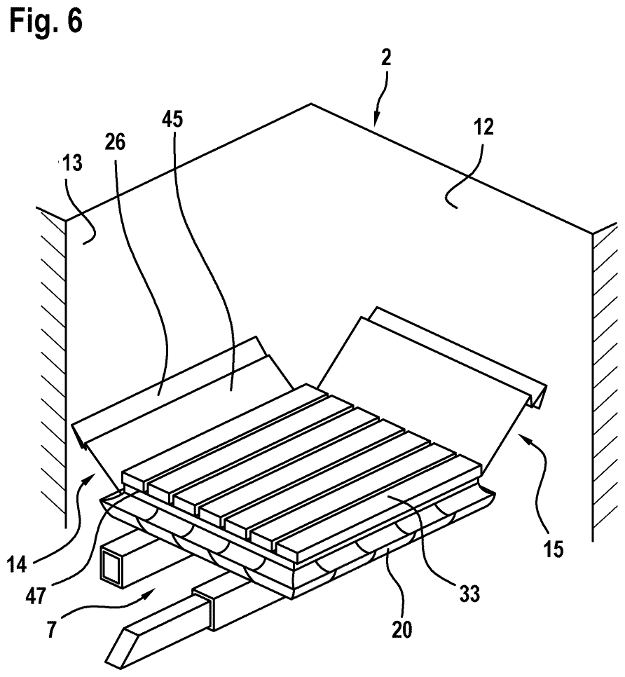

FIG. 6 shows a further platform 7 for an elevator system for a building which is under construction, comprising an elevator shaft 2 which becomes taller as the building height increases during the construction phase of the building. The platform 7 has a sealing arrangement with side elements 14, 15 for sealing with respect to the shaft walls. The horizontal walkable flat roof structure 33 has a multitude of planks. The planks can be made of wooden boards. The flat roof structure 33 may further comprise a floor arranged below the planks, by which water seeping through between the planks can be collected. This floor (not shown here) can have floor drains (see FIG. 4). The flat roof structure 33 is surrounded by a gutter-like water collection container 20. A waterproof film can be arranged between the gutter and the flat roof structure 33 to prevent water from seeping under the platform. The corresponding side element 14, 15 is—as indicated by the arrows A in FIG. 3—designed to be pivotable and can be pivoted to strike against the shaft walls. The corresponding side element 14, 15 consists in the present case of a sheet metal part 45 defining a flank, to which a rubber seal 26 is connected at its upper end. The sealing arrangement of this platform 7 has no corner elements. Thanks to the water collection container 20 in combination with the side elements 14, 15, a fairly good protective and sealing effect can be achieved. However, this platform 7 could also be equipped and retrofitted with corner elements as previously described in FIG. 2 to FIG. 4, which could further significantly improve the sealing effect.

In accordance with the provisions of the patent statutes, the present invention has been described in what is considered to represent its preferred embodiment. However, it should be noted that the invention can be practiced otherwise than as specifically illustrated and described without departing from its spirit or scope.

1-15. (canceled)

16. A platform for an elevator system of a building under construction, the building including an elevator shaft having shaft walls, the elevator shaft becoming taller as the building height increases during a construction phase of the building, the platform comprising:
a roof structure adapted to be temporarily fixed in the elevator shaft extending horizontally with a gap between the platform and the shaft walls;
a circumferential sealing arrangement attached to an edge of the platform, the sealing arrangement being movable between a rest position in which the platform is vertically movable in the elevator shaft and an active position in which the sealing arrangement seals or closes the gap between the platform and the shaft walls; and
wherein the sealing arrangement includes side elements adapted to seal against the shaft walls and corner elements adapted to seal against corner regions where two of the shaft walls at right angles enclose a corner of the elevator shaft, and wherein the side elements are struck against the shaft walls by movement of the corner elements to the active position.

17. The platform according to claim 16 wherein at least one of the corner elements includes a horizontal clamping element.

18. The platform according to claim 17 wherein the horizontal clamping element is a quick-action clamp.

19. The platform according to claim 17 wherein the horizontal clamping element is an angle clamp.

20. The platform according to claim 16 wherein at least one of the corner elements is formed as an angle profile part.

21. The platform according to claim 20 wherein the angle profile part is made of sheet metal.

22. The platform according to claim 20 wherein the angle profile part has inclined drainage portions.

23. The platform according to claim 16 wherein at least one of the corner elements includes a flexible sealing body.

24. The platform according to claim 23 wherein the flexible sealing body is a rubber seal.

25. The platform according to claim 16 wherein at least one of the corner elements projects beyond the side elements in a vertical direction when the roof structure is temporarily fixed in the elevator shaft.

26. The platform according to claim 16 wherein at least one of the side elements has a sheet metal side part with an inclined flank wall and a flexible sealing body.

27. The platform according to claim 26 wherein the sheet metal side part is pivotably fastened to the platform.

28. The platform according to claim 16 wherein at least one of the side elements has a flexible sealing body that forms a flank wall.

29. The platform according to claim 16 wherein at least one of the side elements has an engagement piece adapted to be engaged by one of the corner elements.

30. The platform according to claim 16 including a drainage gap formed between the roof structure and the sealing arrangement.

31. The platform according to claim 16 including a water collection container arranged on the platform below the sealing arrangement, wherein the water collection container is a circumferential gutter.

32. An elevator system for a building under construction, the building having an elevator shaft that becomes taller as the building height increases during a construction phase of the building, the elevator system comprising:
the platform according to claim 16; and
wherein when the sealing arrangement is in the active position, the sealing arrangement seals or closes a gap between the platform and walls of the elevator shaft.

33. A method for erecting an elevator system for a building under construction, the building having an elevator shaft that becomes taller as the building height increases during a construction phase of the building, the method comprising steps of:
temporarily fixing the platform according to claim 16 at a first position in the elevator shaft of the building;
moving the sealing arrangement from the rest position to the active position wherein the side elements seal against with respect to shaft walls of the elevator shaft and the corner elements seal against corner regions between the shaft walls to seal or close a gap between the platform and the shaft walls;
subsequently moving the sealing arrangement from the active position to the rest position; and
moving the sealing arrangement from the rest position to the active position after lifting the platform and temporarily fixing the platform at a second position in the elevator shaft, the second position being higher than the first position.
